(19) United States
(12) Patent Application Publication
(10) Pub. No.: US 2020/0334685 A1
(43) Pub. Date: Oct. 22, 2020

(54) GENERATING WEIGHTED INDICATIONS OF ENTITY PERFORMANCE PATTERNS AND CREDIBILITY DETERMINATIONS TO ENHANCE SECURITY AND CONTEXTUAL AWARENESS IN A TRANSACTION PLATFORM

(71) Applicant: TraDove. Inc., Palo Alto, CA (US)

(72) Inventor: Jun Yan, Palo Alto, CA (US)

(21) Appl. No.: 16/388,237

(22) Filed: Apr. 18, 2019

(51) Int. Cl. G06Q 30/00; G06Q 20/36; H04L 9/06; G06Q 20/38

(52) U.S. Cl. CPC G06Q 30/018; G06Q 20/388; H04L 9/0637; G06Q 20/363

(57) ABSTRACT

Systems and methods of the present disclosure provide participants of a transaction network with an intelligent and dynamic assessment of other participants' credibility, and in particular providing appropriate reassurances of performance, among other reassurances, as between network participants to a possible transaction.

### TECHNICAL FIELD

This disclosure relates to transaction networks, and more specifically some embodiments disclosed herein relate to generating weighted indications of entity performance patterns and/or credibility of participants that provides a novel mechanism to enhance security and contextual awareness in a transaction platform (e.g., in a blockchain supported business-to-business transaction platform).

### BACKGROUND

Transaction platforms are pervasive in today's commercial environment. Such platforms provide many benefits, but also come with a plethora of weaknesses—particularly in terms of security, authentication, verification, privacy, legitimacy, credibility, and actual performance of promises by each participant in a given transaction. One such problem is the double-spend problem that purports to be mitigated by various mechanisms now available through different platforms such as blockchain based platforms. Another problem is the ability of one network participant to effectively verify the credibility of other network participants before transacting business with them. Conventional mechanisms for evaluating a creditability (e.g., a business's credit score and ratings as measured by Dun & Bradstreet, for example) are not helpful in advanced transaction platforms where a performance pattern and/or credibility determination must be made about an entity for which there are little-to-no details known that conventional mechanisms would otherwise rely upon as inputs.

The present disclosure is therefore directed to systems and methods that overcome the aforementioned weaknesses, and some example embodiments in particular generate weighted indications of entity performance patterns and/or credibility of participants that provide a novel mechanism to enhance security and contextual awareness in business-to-business transaction platforms (e.g., in blockchain supported business-to-business transaction platforms).

### SUMMARY

A claimed solution rooted in computer technology overcomes problems specifically arising in the realm of computer technology—namely a business entity credibility and legitimacy problem arising in online business-to-business transaction platforms (e.g., blockchain platforms) where traditional mechanisms for determining entity credibility and legitimacy are inadequate. The systems and methods presented herein provide participants in a transaction network with an intelligent and dynamic assessment of other participants' credibility, and in particular provide appropriate reassurances of performance, among other reassurances, as between network participants to a possible transaction.

In accordance with some embodiments of the present disclosure, a system is provided that includes: one or more processors; and one or more memory devices storing instructions that, when executed by the one or more processors, cause the system to perform operations of: generate a credibility score associated with a network participant, the credibility score based on a weighted combination of an on-platform transaction score, an off-platform transaction score, a transactor feedback score, a personnel feedback score, an endorsement score, a trade activity score, a financial health score and a transactor credibility score associated with the network participant; wherein, to generate the credibility score, one or more weighting factors is applied to each of the on-platform transaction score, the off-platform transaction score, the transactor feedback score, the personnel feedback score, the endorsement score, the trade activity score, the financial health score, and the transactor credibility score; and wherein the one or more weighting factors is adjustable.

In some embodiments, the on-platform transaction score is determined based on one or more of an on-platform transaction volume measure, an on-platform transaction value measure, and an on-platform transaction success measure associated with the network participant. In some embodiments, the off-platform transaction score is based on one or more of an off-platform transaction volume measure, an off-platform transaction value measure, and an off-platform transaction success measure associated with the network participant. In some embodiments, the transactor feedback score is based on feedback from one or more other network participants that have previously attempted to transact with the network participant. In some embodiments, personnel feedback score based on one or more of an employee feedback measure, and subcontractor feedback measure.

In some embodiments, the personnel feedback score is weighted based on the relevance of the feedback providers role in prior transactions. In some embodiments, the endorsement score is based on one or more of a third-party endorsement of the network participant, and a network participant endorsement of a third-party. In some embodiments, the one or more third-party endorsements correspond to a perceived attribute of the network participant. In some embodiments the perceived attribute of the network participant corresponds to one or more of an environmental awareness measure, a diversity measure, a fiscal responsibility measure, an animal cruelty measure, an employment practice measure, a political preference measure, and a religious preference measure, a fraudulent activity measure, a public perception measure, a public interest measure, and a donation measure. In some embodiments, the trade activity score is based on one or more of an import measure and an export measure of the network participant. In some embodiments, the trade activity score is based only upon those import measures and export measures that are specific to one or more of a product or service. In some embodiments, the financial health score is based on one or more of a revenue measure, a debt measure, an asset measure, a liability measure, report submitted to a securities exchange platform, a security value measure, and a security value measure. In some embodiments, the transactor credibility score is based on the credibility score of another network participant with whom the network participant has transacted.

In accordance with some embodiments of the present disclosure, a method is provided that involves: determining a credibility score associated with a network participant, the credibility score based on a weighted combination of an on-platform transaction score, an off-platform transaction score, a transactor feedback score, a personnel feedback score, an endorsement score, a trade activity score, a financial health score, and a transactor credibility score associated with the network participant; wherein, to determine the credibility score, one or more weighting factors is applied to each of the on-platform transaction score, the off-platform transaction score, the transactor feedback score, the personnel feedback score, the endorsement score, the trade activity score, and the financial health score; and wherein the one or more weighting factors is adjustable. In some embodiments, the on-platform transaction score is determined based on one or more of an on-platform transaction volume measure, an on-platform transaction value measure, and an on-platform transaction success measure associated with the network participant. In some embodiments, the off-platform transaction score is based on one or more of an off-platform transaction volume measure, an off-platform transaction value measure, and an off-platform transaction success measure associated with the network participant. In some embodiments, the transactor feedback score is based on feedback from one or more other network participants that have previously attempted to transact with the network participant.

In some embodiments, the personnel feedback score based on one or more of an employee feedback measure, and subcontractor feedback measure. In some embodiments, the personnel feedback score is weighted based on the relevance of the feedback providers role in prior transactions. In some embodiments, the endorsement score is based on one or more of a third-party endorsement of the network participant, and a network participant endorsement of a third-party. In some embodiments, the one or more third-party endorsements correspond to a perceived attribute of the network participant. In some embodiments, the perceived attribute of the network participant corresponds to one or more of an environmental awareness measure, a diversity measure, a fiscal responsibility measure, an animal cruelty measure, an employment practice measure, a political preference measure, and a religious preference measure, a fraudulent activity measure, a public perception measure, a public interest measure, and a donation measure. In some embodiments, the trade activity score is based on one or more of an import measure and an export measure of the network participant; In some embodiments, the trade activity score is based only upon those import measures and export measures that are specific to one or more of a product or service. In some embodiments, the financial health score is based on one or more of a revenue measure, a debt measure, an asset measure, a liability measure, report submitted to a securities exchange platform, a security value measure, and a security value measure. In some embodiments, the transactor credibility score is based on the credibility score of another network participant with whom the network participant has transacted.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example lightweight blockchain network environment within which one or more embodiments of the present disclosure may be implemented.

FIG. 2 is a diagram illustrating example architectural componentry of a UNode of the example lightweight blockchain network environment shown in FIG. 1, within which one or more embodiments of the present disclosure may be implemented.

FIG. 3 is a diagram illustrating example architectural componentry of an INode of the example lightweight blockchain network environment shown in FIG. 1, within which one or more embodiments of the present disclosure may be implemented.

FIG. 4 is a diagram illustrating example architectural componentry that may be embodied within one or more nodes in an example blockchain network environment to generate a credibility assessment in accordance with one or more embodiments of the present disclosure.

FIG. 5 illustrates an operational flow diagram illustrating an example method that may be implemented to in accordance with one or more embodiments of the present disclosure.

FIG. 6 illustrates an operational flow diagram illustrating an example method that may be implemented to in accordance with one or more embodiments of the present disclosure.

FIG. 7A illustrates an example user interface for conducting an intelligent search query to identify entities for consideration for a potential transaction (also referred to herein as an intelligent search query interface), based on the disclosed credibility scores, in accordance with one or more embodiments of the present disclosure.

FIG. 7B illustrates an example interactive detail interface 750 which may be presented responsive to user selection of one or more elements of an example intelligent search query interface in accordance with one or more embodiments of the present disclosure.

FIG. 8 illustrates an example tree structure reflecting a rank of network participants based on generated credibility scores for each.

FIG. 9 is an example computing device that may be used to implement various features of embodiments described in the present disclosure.

The figures are not exhaustive and do not limit the present disclosure to the precise form disclosed.

### DETAILED DESCRIPTION

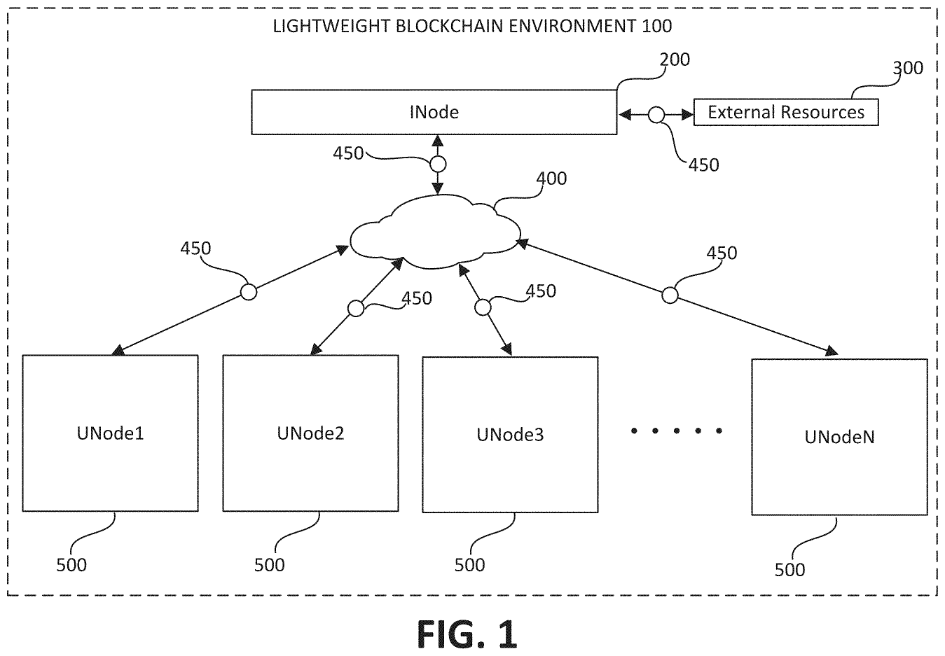

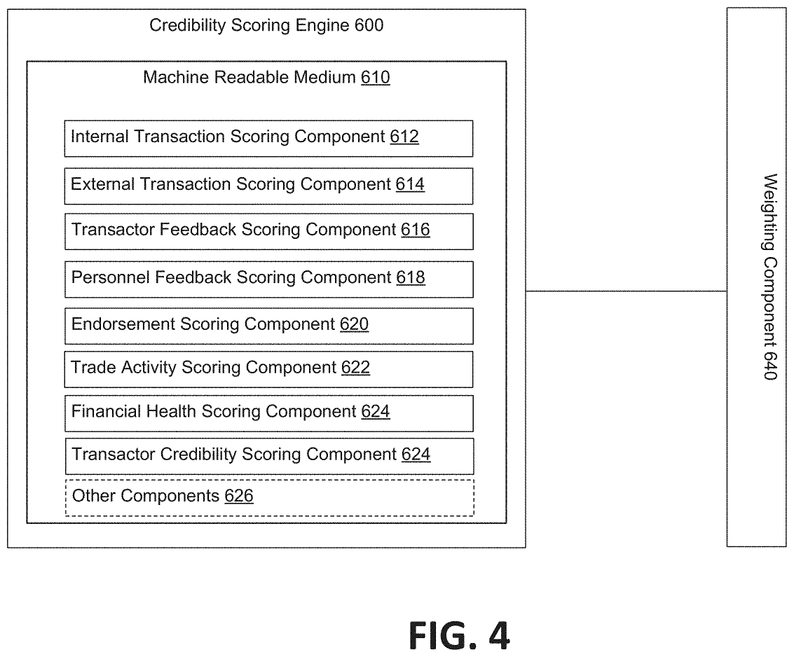

Systems and methods of the present disclosure provide advanced credibility assessment and scoring technologies that may be configured for implementation in any online or virtual transaction environment. By way of example, such a transaction platform may include a blockchain networking environment such as those disclosed in U.S. application Ser. Nos. 16/198,741 and 62/770,738, incorporated herein by reference in their entirety. Before discussing credibility scoring features in depth (FIGS. 4-8), a description of example lightweight blockchain transaction platforms within which one or more embodiments of the present disclosure may be implemented is provided (FIGS. 1-3).

As shown, FIG. 1 is a diagram illustrating an example blockchain networking environment within which one or more embodiments of the present disclosure may be implemented. Blockchain networking environment 100 may include a plurality of nodes in communication with one another over network 400 via communication links 450. A “node” refers to any device that participates in a blockchain network. A node can comprise or be coupled with any active electronic device, such as, by way of example, laptop or desktop computers, smartphones, servers, tablets, netbooks, or even printers and other simple electronic devices. Nodes are coupled to or equipped with wired or wireless communication components allowing them to connect to and communicate with other Nodes over network 400, such as, by way of example, communication with other nodes over network 400 (e.g., over the Internet using an Ethernet, Wi-Fi, or Cellular connection, for example).

As shown, the nodes of blockchain networking environment 100 include multiple user nodes, UNode1, UNode2, . . . UNodeN communicatively coupled with one or more identity nodes, INode 200, the INode being further communicatively coupled with one or more external resources 300.

An INode (i.e., an “identity node”) is a node that is associated with a centralized identity verification and account management entity (e.g., TraDove), and a UNode (i.e., an “user node”) is a node that is associated with a network participant (e.g., a business, an organization, an institution, a person, an entity, or other user). For example, INode 200 may be embodied in one or more computer systems associated with a financial institution (e.g., a bank), and each UNode 500 may be embodied in one or more computer systems associated with a potential transactor on the network (e.g., potential buyers and potential sellers).

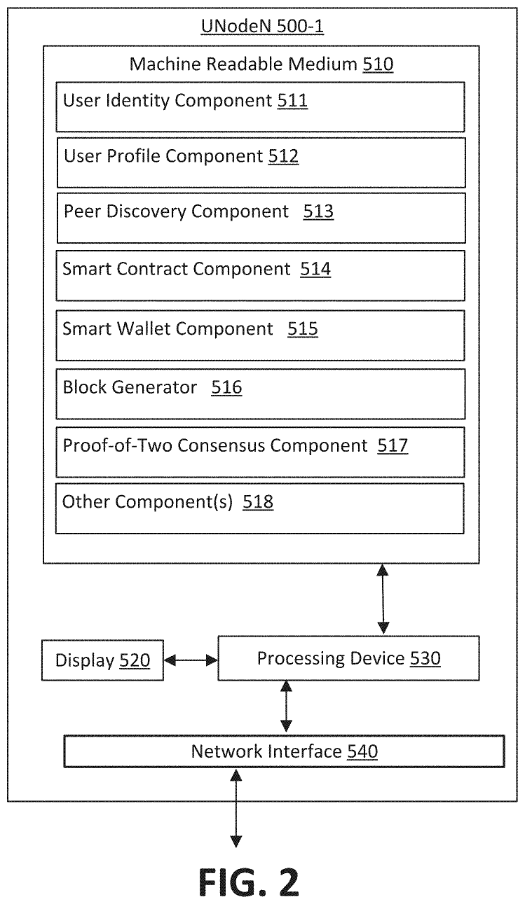

A UNode is configured to support the blockchain network embodiments of the present disclosure by maintaining a node-specific copy or partial copy of a blockchain (e.g., a copy of a blockchain that corresponds only to the transactions made by and with the network participant associated with that UNode). As described further with reference to FIGS. 2-10, a UNode is configured to check new transactions to be added to its blockchain using a novel Proof-Of-Two consensus protocol in accordance with one or more embodiments of the present disclosure. In some instances, a UNode can be configured to process transactions. Individual UNodes 500 may be embodied in one or more computer systems associated with individual network participants, where network participants are entities registered with blockchain network 100, and who may, upon satisfying requirements, participate in transactions with other network participants on a transaction platform supported by the blockchain network 100. In connection with the technology presented by the present disclosure, respective roles and functionality of the INode 200 and individual UNodes 500 in the blockchain network are discussed in further detail with respect to FIGS. 2-10.

Individual UNodes 500 may be embodied in computer systems associated with individual network participants, where network participants are entities registered with blockchain network 100, and who may, upon satisfying requirements, participate in transactions with other network participants on a transaction platform supported by the blockchain network 100.

Communication links 450 may connect nodes and/or other resources within blockchain networking environment 100 to network 400, and thereby to each other. Communication links 450 may be dynamically reconfigurable such that new nodes and/or other resources may be connected to or removed from the blockchain networking environment 100 as the network evolves with new and/or different participants, and new and/or different resources. Communication links 450 may include any type of link. For example, one or more links 450 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), optical (such as for example Synchronous Optical Network (SONET) or Synchronous Digital Hierarchy (SDH)) links, or any one or more of an ad hoc network, an intranet, an extranet, a VPN, a LAN, a WLAN, a WAN, a WWAN, a MAN, a portion of the Internet, a portion of the PSTN, a cellular technology-based network link, a satellite communications technology-based network link, another link 450, or a combination of two or more such links 450. Links 450 need not be the same throughout blockchain networking environment 100. Indeed, one or more first links 450 may differ in one or more respects from one or more second links 450. Communication over links 450 may include any request to send or receive any type of information accessible within blockchain networking environment 100.

Network 400 may include any type of communication network. As an example and not by way of limitation, one or more portions of network 400 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these.

In connection with the technology presented by the present disclosure, respective roles and functionality of INode 200 and individual UNodes 500 in the blockchain network will be discussed in further detail below with respect to FIGS. 2-10.

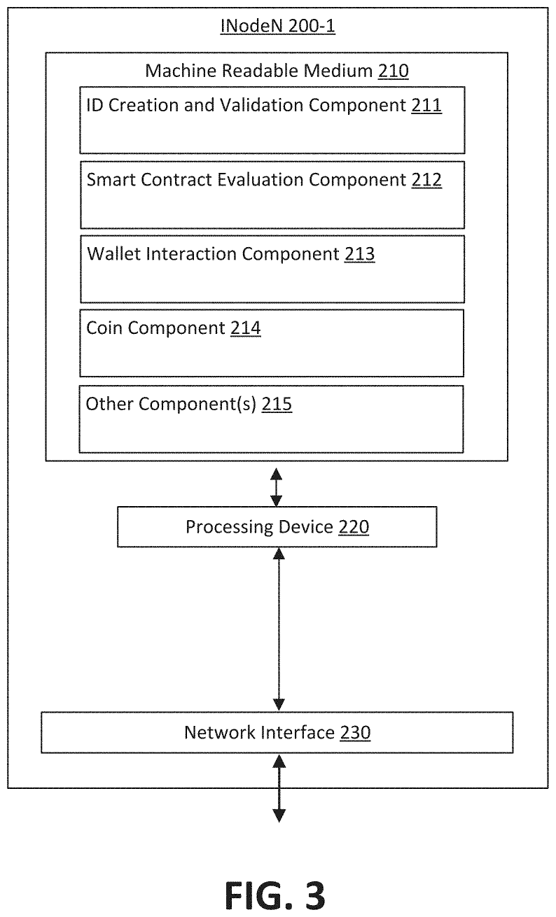

FIG. 2 is a diagram illustrating an example architecture of components of an example UNode 500-1, in accordance with one or more embodiments of the present disclosure. FIG. 3 is a diagram illustrating an example architecture of components of an example INode 200-1, in accordance with one or more embodiments of the present disclosure. Each component of the example UNode and example INode will be introduced here with reference to FIGS. 2-3, followed by additional features and context provided in examples discussed with reference to FIGS. 4-6.

Referring now to FIG. 2, UNodeN 500-1 may include a machine readable medium 510 having instructions stored thereon, which, when executed by one or more processors, cause one or more of the disclosed features to be effectuated. The machine readable medium may have machine readable code comprising a User Identity Component 511, User Profile Component 512, Peer Discovery Component 513, Smart Contract Component 514, Smart Wallet Component 515, Proof-of-Two Consensus Component 517, and/or Block Generator 516.

User Identity Component 511 acquires, stores, encrypts, and/or maintains identifying information associated with the particular network participant associated with the particular UNode. Such identifying information may include any static or dynamic information that, considered alone or taken together, is unique to a network participant among the plurality of network participants. By way of example, such identifying information may include (i) a unique user ID and/or password created during the network participant's registration with blockchain networking environment 100, (ii) a unique user ID and/or password associated with another service or platform that network participant subscribes to or maintains a membership with (e.g., LinkedIn, Instagram, Facebook, Gmail, Outlook, ABC Bank) and/or has concurrently (or within a predetermined period of time) accessed on the same computing device hosting the UNode, (iii) a serial number or electronic ID of the computing device hosting the UNode, (iv) real-time or previously measured digital fingerprint information, retinal scan information, face recognition, or other biometric information, (v) sensed information accessible to or through the computing device hosting the UNode associated with the network participant (e.g., GPS location information, temperature information, biometric information, audio/voice information, etc.), (vi) selected security questions and/or answers thereto, (vii) images, videos or other multimedia, (viii) a social security number, a date of birth, a government issued ID number (e.g., drivers license number, TaxID number), (ix) revenue information associated with the network participant, or anything else desired in the context of a transaction. One of skill in the art will appreciate that many other forms of identifying information may be acquired, stored, encrypted, and/or maintained by User Identity Component 511.

User Identity Component 511 may further create a unique hash identifier (“referred to herein as a NodeIDAddress) for the user that is based upon one or more pieces of such identifying information as an input to a hashing algorithm, or a unit of information assigned to the new network participant by the INode 200. During a network participant's initial registration with the blockchain network 100, INode 200 may create and digitally sign an initial entry and create a genesis block for the particular UNode 500 chain that is based, in whole or in part, on the NodeIDAddress. The signing of the initial entry by the INode 200 (e.g., using a cryptographic key) allows only the INode 200 to create and/or approve a genesis block within a new network participant's node-specific blockchain. In some instances the unique identifier may be assigned or provided as part of the node's participation in a blockchain transaction.

User Profile Component 512 receives input from a network participant (or an authorized representative of the network participant) regarding the appearance and content of a profile that may be searchable and viewable by peer network participants also registered to transact within blockchain networking environment 100. User Profile Component 512 may generate and/or make available for display, alone or in coordination with other resources within blockchain networking environment 100 (e.g., a server supporting INode 200), a digital profile that is searchable and/or viewable by peer network participants within the blockchain networking environment 100 (e.g., by searching a blockchain network participant database from an interface displayed through a display of a computing device hosting another UNode 500-1). User Profile Component 512 may also receive input or feedback from a peer networking participant in connection with the generated user profile. Such input or feedback may be provided for display on the network participant's user profile such that other peer networking participants can observe the input or feedback when viewing the network participants user profile. For example, input or feedback from a peer networking participant may include a rating concerning a prior transaction experience, a recommendation based on other information, a review, etc.). User Profile Component 512 may further monitor the network participant's activities (e.g., transactions) over the Network 400 (shown in FIG. 1), and generate, store, and/or make available for display information relating to such activities (e.g., transaction statistics, etc.).

Peer Discovery Component 513 provides, alone or in coordination with other resources within blockchain networking environment 100 (e.g., a server supporting INode 200), a search engine allowing a first network participant to search and view the User Profiles of other peer network participants who may be open to transacting business with the first network participant within the blockchain networking environment 100. In some embodiments, such User Profiles may include one or more credibility scores (discussed in more detail with reference to FIGS. 4-6), and such search engine features may include one or more filters based on such credibility scores, or based on any information underlying such credibility scores).

Smart Contract Component 514 may receive, create, and/or provide, alone or in coordination with other resources within blockchain networking environment 100 (e.g., a blockchain supported transaction platform running on a server supporting INode 200), a smart contract that can be shared with, digitally edited by, collaborated upon, and agreed to by multiple network participants. Smart Contract Component 514 may provide for display on an interface a user-friendly and human readable version of the smart contract, which may further include one or more fields and/or buttons for editing, modifying, accepting, rejecting, agreeing and/or digitally signing one or more provisions of a draft smart contract, and/or for providing a final approval for the automated execution of the smart contract once each network participant who is a party to the smart contract has satisfied all of the necessary terms. It will be appreciated that a “smart contract” as used herein comprises self-executing code residing on a blockchain network (e.g., on INode 200, one or more UNodes 500, or other blockchain network resource, or a combination of the foregoing), which, when executed effectuates completion of the associated transaction (e.g., it automatically executes a payment and/or delivery term of the contract) between trusted UNodes based on events that took place in connection with a blockchain supported transaction platform.

Smart Wallet Component 515 maintains and secures, alone or in coordination with other resources within blockchain networking environment 100 (e.g., a server supporting INode 200), a digital wallet owned by the network participant and associated with the given UNode. The digital wallet may include a network participants cryptocurrency holdings, blockchain network accounts, and private/public keys associated therewith. Smart Wallet Component 515 can be configured to provide management functionality, alone or in coordination with other resources within blockchain networking environment 100, such as transferring, converting, sending, receiving, releasing, exchanging, depositing, withdrawing, moving, securing or otherwise operating on cryptocurrency funds and/or fiat funds upon request. Smart Wallet Component 515 may further be configured to execute code to lock cryptocurrency coins, or allow a digitally signed smart contract to lock coins, in an amount sufficient to support the transaction described in the smart contract, etc. In some embodiments, Smart Wallet Component 515 may further be configured to execute code that causes the system to refund, release, receive, transfer, send, lock an amount of cryptocurrency to another network participant. In some embodiments, Smart Wallet Component 515 may further be configured to execute code to provide balance reporting after one or more transactions has occurred involving currency managed by the given Smart Wallet of a network participating, which may be accessible or viewable via a user device or other device within the blockchain networking environment. In some embodiments, Smart Wallet Component 515 may further be configured to facilitate back-up (e.g., periodic back-up, on demand back-up, or one-time back-up) for later restoration by a given network participant as needed (e.g., if the given network loses their digital wallet (e.g., loses their UNode device such as their smart phone)).

Block Generator 516 applies a hashing algorithm to an input to generate a proposed next block (a data structure shown in FIG. 3) for addition onto the blockchain. The input to the hashing algorithm includes the information from the most recently added block in the blockchain (including its cryptographic key), as well as the information for the one or more transactions that are claimed to have occurred after the most recent block was added to the chain. In some instances, the most recent block in the chain will be a genesis block (e.g., for new network participants). Blocks generated by Block Generator 516 will be added to the UNode 500-1's blockchain if consensus is reached pursuant to a Proof-of-Two Consensus protocol.

Proof-of-Two Consensus Component 517 (also referred to herein as “Po2” Consensus Component 517) comprises a predetermined consensus protocol which, when executed by a processor of the computing system hosting UNode 500-1, applies Po2 consensus rules to determine whether or not the transaction(s) represented by a proposed block actually occurred as represented. For example, when a block is proposed for addition to the blockchain, and the block includes one or more records of transactions claimed to have been executed in accordance with one or more smart contract of the present disclosure, the Po2 Consensus Component 517 at each UNode that was a party to the underlying transactions will apply the Po2 consensus rules to the proposed block to decide whether or not the underlying transactions represented by the proposed block are true/valid (i.e., that each UNode that was a party to the underlying transaction(s) sent and received what each intended to send and receive pursuant to the smart contract). Upon receiving unanimous acceptance/validation between the two UNode's associated with a two-party transaction, the Po2 consensus rules satisfied and the proposed block may be added to each participating UNode 500's blockchain. As such, the only blocks added to a particular UNode's blockchain are those that include transactions to which the particular UNode 500 was a party. Thereby, the version of the blockchain maintained by each UNode 500 is lightweight in that it involves far fewer and less complex blocks (on account of far fewer transactions), and fewer nodes executing less computationally intensive algorithms to arrive at a consensus before a block is added to a chain.

As further shown in FIG. 2, UNodeN 500-1 may be comprise or otherwise be operatively coupled with a display 520, a processing device 530, and a network interface 540. Display 520 may be any digital display that displays visual information based on instructions executed by a processor connected thereto. For example, display 520 may include touchscreen displays, computer monitor displays, television displays, etc. Processing device 530 may include one or more processors that performs processing operations or a combination of specialized and/or general-purpose processors that perform processing operations. For example, processing device 530 may include a CPU, GPU, APU, DSP, FPGA, ASIC, SOC, and/or other processing circuitry. Network interface 540 may be any communication circuit configured for communicating over a wired or wireless network. Network interface 540 provides a two-way data communication through network 400 over one or more communication links 450 (FIG. 1). For example, network interface 540 may be an integrated services digital network (ISDN) card, cable modem, satellite modem, a cellular chipset, or a modem to provide a data communication connection to a corresponding type of communication line. As another example, network interface 540 may be a local area network (LAN) card to provide a data communication connection to a compatible LAN (or WAN component to communicated with a WAN). Network interface 540 may send and receive electrical, electromagnetic, optical or other signals that carry digital data streams representing various types of information. It will be appreciated that one or more of display 520, processing device 530, and network interface 540 may be embodied in any type of computing device (e.g., a smartphone).

Referring now to FIG. 3, INode 200-1 may include a machine readable medium 210 having instructions stored thereon, which, when executed by one or more processors, cause one or more of the disclosed features to be effectuated. The machine readable medium may have machine readable code comprising a ID Creation and Validation Component 211, a Smart Contract Evaluation Component 212, a Wallet Interaction Component 213, a Coin Component 214, and/or one or more Other Component(s) 215.

ID Creation and Validation Component 211 receives information from prospective network participants, and if approved, registers a UNode into the blockchain networking environment that is associated with the approved prospective network participant, and a corresponding NodeIDAddress. For example, using a network participant's initial registration with the blockchain network 100, INode 200 may create and digitally sign an initial entry and create a genesis block for the particular UNode 500 chain that is based, in whole or in part, on the NodeIDAddress. The signing of the initial entry by the INode 200 (e.g., using a cryptographic key) allows only the INode 200 to create and/or approve a genesis block within a new network participant's node-specific blockchain. Further, whenever a registered UNode 500 requests to provide any input into the blockchain networking environment (e.g., a request to interact with another network participant in connection with a potential smart contract supported transaction, a request to modify or provide feedback concerning a user profile, etc.), ID Creation and Validation Component 211 may authenticate and/or validate the participant in any manner desired for the context of the request, for example, by using a single sign-on authentication, two-factor authentication, biometric authentication, active directory authentication, certificate-based authentication, NodeIDAddress authentication, or any other type of authentication of a centralized identity of the network participant. In some embodiments, authentication and/or validation procedures are facilitated only when a UNode user attempts to login to the network, but not for each and every transaction that a UNode participates in over the network after login. In some embodiments, authentication and/or validation procedures are facilitated on a per-transaction basis (e.g., authentication and/or validation procedures occurring each time a UNode attempts to participate in a transaction). Authentication may be performed in response to receiving input (e.g., credentials) from a computing device associated with a UNode 500 in the blockchain networking environment 100.

Smart Contract Evaluation Component 212 receives information about one or more terms in a smart contract that has been accepted and digitally signed by the parties, and if necessary instructs Wallet Interaction Component 213 to take an action, alone or in coordination with a given UNode's Smart Wallet Component 515. In some embodiments the one or more terms includes a payment term, and the action includes locking a number of coins in a UNode 500's digital wallet in an amount sufficient for the transaction underlying the smart contract to be completed. Locking coins may involve placing a restriction on the use, transferability, or representation of a coin such that it may only be used for a single, preapproved purpose.

Although Smart Contract Evaluation Component 212 is shown in FIG. 3 as being part of INode 200, in some embodiments such componentry and associated functionality exists at the UNode 500 level. That is, Smart Contract Evaluation Component may exist and be executed at UNodes 500 operating within the platform. In such an embodiment Smart Contract Evaluation Component of a UNode 500 may receive information about one or more terms in a smart contract that has been accepted and digitally signed by the parties, and if necessary instructs Wallet Interaction Component (which, as discussed below, may also exist at the UNodes 500) to take an action, alone or in coordination with a given UNode's Smart Wallet Component 515. In some embodiments the one or more terms includes a payment term, and the action includes locking a number of coins in the respective UNode 500's digital wallet in an amount sufficient for the transaction underlying the smart contract to be completed. Locking coins may involve placing a restriction on the use, transferability, or representation of a coin such that it may only be used for a single, preapproved purpose. Thus, in such an embodiment, the UNode may lock up its own (or another participating party's) coins in connection with a transaction.

Wallet Interaction Component 213 receives instructions from Smart Contract Evaluation Component concerning actions to be taken with respect to a digital wallet of a UNode 500 within the blockchain networking environment. Wallet Interaction Component 213 may receive and effectuate any action with respect to a UNode's digital wallet, including by way of example, locking coins, effectuating a release or transfer of coins from one digital wallet to another digital wallet, effectuating an exchange of coins for cash, effectuating deposits, withdrawals, and so on.

Although Wallet Interaction Component 213 is shown in FIG. 3 as being part of INode 200, in some embodiments such componentry and associated functionality exists at the UNode 500 level. That is, Wallet Interaction Component may exist and be executed at UNodes 500 operating within the platform. In such an embodiment Wallet Interaction Component of a UNode 500 may receive instructions from Smart Contract Evaluation Component concerning actions to be taken with respect to a digital wallet of a UNode 500 within the blockchain networking environment. Wallet Interaction Component of a UNode 500 may receive and effectuate any action with respect to a UNode's digital wallet, including by way of example, locking coins, effectuating a release or transfer of coins from one digital wallet to another digital wallet, effectuating an exchange of coins for cash, effectuating deposits, withdrawals, and so on. Thus, in such an embodiment, the UNodes of the platform may perform any of foregoing on behalf of itself (or another participating party) in connection with a transaction.

Coin Component 214 is configured to exchange fiat currency for cryptocurrency, minting new coins as needed, and burning previously used coins as necessary. For example, a network participant associated with a UNode 500 may wish to wire cash (fiat currency) into an INode 200 controlled account in exchange for the INode 200 minting and depositing a number of coins into an account in the digital wallet of the given UNode 500 (at a predetermined rate of exchange, e.g., 1 coin deposited for each $1 USD wired). Alternatively, a network participant associated with a UNode 500 may wish to receive a cash wire (of fiat currency) from an INode 200 controlled account in exchange for releasing to the INode 200 a number of coins that the UNode 500 has acquired and secured in their digital wallet (again, at the predetermined rate of exchange, e.g., 1 coin deposited for each $1 USD wired). Coin Component 214 facilitates this exchange, alone or in connection with Wallet Interaction Component 213 of INode 200 and Smart Wallet Component 515 of a UNode 500.

Coin Component 214 may receive fiat funds from third party institutions associated with network participants. For example, a network participant may have a bank account with ABC Bank, and instruct ABC Bank to wire $100 to an account and routing number associated with an entity in control of UNode1 500-1. Upon receipt of the $100 wire, INode1 200 may, via one or more of its Coin Component 214 and Wallet Interaction Component 213, mint and/or deposit 100 coins into the digital wallet of UNode1 500-1.

Other Component(s) 215 of INode 200 may be configured to implement various other features desirable in the given environment. For example, in some contexts it will be desirable for the INode to communicate to relevant UNodes various updates concerning completion of a transaction or other metrics associated with a given transaction. For example, INode 200 may communicate and/or facilitate updates to the token or fiat balances pursuant to the completed transaction, or communicate and/or facilitate transaction statistics for/to each UNode500 that participated in a particular transaction. In some embodiments, Other Component(s) 215 may be configured to facilitate the sale of tokens held or otherwise owned by the INode 200 controlling entity (e.g., TraDove) in addition or as an alternative to minting new tokens.

FIG. 4 is a diagram illustrating example architectural elements that may be embodied within one or more nodes in an example blockchain network environment, or in one or more servers coupled thereto, in accordance with one or more embodiments of the present disclosure. As shown in FIG. 4, such example architecture may include a credibility scoring engine 600 which may include a machine readable medium 610 having instructions stored thereon, which, when executed by one or more processors, cause one or more of the disclosed credibility scoring features to be effectuated. The machine readable medium may have machine readable code comprising internal transaction scoring component 612, external transaction scoring component 614, transactor feedback scoring component 616, personnel scoring component 618, endorsement scoring component 620, trade activity scoring component 622, and/or financial health scoring component 624, transactor credibility scoring component 626, among other components 628.

Credibility scoring engine 600 may be configured to determine one or more credibility scores for a network participant of a transaction network. An example credibility score computed by the credibility scoring engine 600 may be based on a weighted combination of one or more of an on-platform transaction score associated with the network participant, an off-platform transaction score associated with the network participant, a transactor feedback score associated with the network participant, a personnel feedback score associated with the network participant, an endorsement score associated with the network participant, a trade activity score associated with the network participant, a financial health score associated with the network participant, and/or and a transactor credibility score associated with the network participant. The credibility score(s) may be informed by the outputs resulting from execution of the instructions comprising the internal transaction scoring component 612, external transaction scoring component 614, transactor feedback scoring component 616, personnel scoring component 618, endorsement scoring component 620, trade activity scoring component 622, and/or financial health scoring component 624, transactor credibility scoring component 626, among other components 628, as well as the weighting component 640 communicatively coupled thereto.

Internal transaction scoring component 612 may be configured to generate a score representing the transaction history of the network participant's activity on a given transaction network. The transaction history considered in generating such a score may include a network participant's entire history of activities on the given transaction network, or it may consider a network participant's history of activities on the given transaction network during a specific timeframe (e.g., activity over the last 5 years, etc.), or other select history (e.g., a number of past transactions with a particular type of network participant—for instance, a number of past transactions with suppliers or sellers, and/or a number of past transactions with customers or buyers, etc.), or combination of the foregoing. By way of example, the on-platform transaction score may be based upon one or more of an on-platform transaction volume measure (e.g., the total, average, median, or other statistical measure of successful and/or failed transactions executed on the transaction network over a designated period, or an entire period), an on-platform transaction value measure (e.g., the total, average, median, or other statistical measure of value (e.g., dollar amounts) of transactions executed on the transaction network over a designated period, or an entire period), and an on-platform transaction success measure associated with the network participant (e.g., a percentage, or other statistical measure, of transactions executed on the transaction network that reached successful closing or completion, which may be verified by the other network participant(s) that were parties to such transactions). In some embodiments a transaction volume measure may be an average transaction volume with all or one or more subsets of other parties of a particular type with whom the network participant has transacted on the platform (e.g., average transaction volume with suppliers or sellers, and/or average transaction volume with customers or buyers, etc.)

External transaction scoring component 614 may be configured to obtain transaction details from one or more external sources, and generate a score representing the transaction history of the network participant's off-platform activities (e.g., transactions occurring on external transaction networks or elsewhere). The transaction history considered in generating such a score may include a network participant's entire history of activities that can be verified to have occurred off-platform, or it may consider a network participant's history of off-platform activities during a specific timeframe (e.g., activity over the last 5 years, etc.) or other select history (e.g., a number of past transactions with a particular type of market player—for instance, a number of past transactions with suppliers or sellers, and/or a number of past transactions with customers or buyers, etc.), or combination of the foregoing. By way of example, the off-platform transaction score may be based upon one or more of an off-platform transaction volume measure (e.g., the total, average, median, or other statistical measure of successful and/or failed transactions executed off-platform over a designated period, or an entire period), an off-platform transaction value measure (e.g., the total, average, median, or other statistical measure of value (e.g., dollar amounts) of transactions executed off-platform over a designated period, or an entire period), and an off-platform transaction success measure associated with the network participant (e.g., a percentage, or other statistical measure, of transactions executed off-platform that reached successful closing or completion, which may be verified by the other parties to such transactions).

Transactor feedback scoring component 616 may be configured to obtain feedback about a particular network participant from other network participants who have transacted with the particular network participant in the past, and generate a transactor feedback score representative of such feedback. The feedback may be obtained by prompting network participants to provide rankings or enter responses to various questions about the other participants involved in a particular transaction, or in any other manner desired for obtaining such feedback in a given scenario. Such feedback may be of any type or quality, or may address any topic. For example, transactor feedback scoring component 616 may prompt one network participant to provide feedback related to the quality of a product or service provided by another network participant with whom they have transacted on the given transaction network. In another example, transactor feedback scoring component 616 may prompt one network participant to provide feedback related to payment punctuality or delinquency related to another network participant with whom they have transacted on the given transaction network. Although the above examples are provided in the context of a prompt generated by the transactor feedback scoring component 616, such feedback may be obtained by other means, such as feedback provided by the other network participants about the particular network participant on their own initiative (i.e., without being prompted) via a comment field or other input mechanism available to such other network participants. In some embodiments the feedback is obtained in the form of a peer ratings provided by all or one or more subsets of other parties of a particular type with whom the particular network participant has conducted business (e.g., one or more peer ratings by the network participant's suppliers or sellers, and/or one or more peer ratings by the network participant's suppliers or buyers). Transactor feedback scoring component 616 may also be configured to obtain feedback about a particular network participant from a non-network participant.

Personnel scoring component 618 may be configured to obtain feedback about a particular network participant from personnel who have performed work on behalf of the network participant (e.g., as an employee, subcontractor, consultant, etc.), and generate a personnel feedback score representative of such feedback. Such feedback may be of any type or quality, or may address any topic. For example, personnel scoring component 618 may prompt an employee of a network participant to provide feedback related to an aspect of the workplace (e.g., diversity, harassment, promotion, discrimination, working environment, or other employment practices), an aspect of a product or service provided by the network participant (e.g., quality standards, turnaround times, recall information, compatibility, customer complaints, resolution times), or any other aspect of the network participant for which personnel of the network participant may have specialized insight (e.g., outstanding debts, credit facility status, security interests, etc.). Although the above examples are provided in the context of a prompt generated by the personnel scoring component 618, such feedback may be obtained by other means, such as feedback provided by personnel about the particular network participant on their own initiative (i.e., without being prompted) via a comment field or other input mechanism available to such personnel. In some embodiments, the personnel feedback score may be based on one or more of an employee feedback measure, a subcontractor feedback measure, and a consultant feedback measure. Because some employee feedback may not be of sufficient relevance to the profile of a network participant (e.g., the janitor of a company may have little reliable insight about the company's credit facilities or product quality, for instance), the aforementioned feedback scores may be weighted, filtered out, or otherwise adjusted based upon the role of the personnel member providing the feedback.

Endorsements scoring component 620 may be configured to obtain endorsement information from an external source (e.g., a third party) that concerns a measured or perceived attribute of the network participant, and generate an endorsements score representative of such endorsements. Such endorsement information may include, for example, awards and recognitions given by one or more independent organizations—e.g., a Thomson Reuters sponsored D&I Index measure in recognition of the diversity and inclusion efforts of the network participant; a Newsweek sponsored Environmental Performance measure concerning the environmental impact and/or preservation efforts of the network participant; a Catalyst Award reflecting a measure of progressive initiatives that engender advancement of women at the workplace of the network participant; a supply chain reliability measure concerning the performance reliability of a network participant in supply chain relationships; etc. In some embodiments, the endorsements score generated may be based upon endorsements that the network participant provides in connection with other entities or platforms (e.g. an endorsement of a candidate for political office, an endorsement of a particular social cause or viewpoint, endorsement of a third party company that has a pronounced agenda or objective (e.g., a religious organization, an affirmative action group, etc.). In some embodiments, the perceived or measured attribute of the network participant corresponds to one or more of: an environmental awareness measure, a diversity measure, a fiscal responsibility measure, an animal cruelty measure, an employment practice measure, a political preference measure, a religious preference measure, a fraudulent activity measure, a public perception measure, a public interest measure, and a donation measure.

Trade activity scoring component 622 may be configured to obtain import or export information in connection with a network participant, and generate a trade activity score representative of such import and/or export information. Such trade activity information may be obtained from public databases (e.g., customs or duties government databases) or a private database. In some embodiments, the trade activity scoring component may generate a product- or component-specific trade activity score representative of import and/or export activity by the network participant in connection with the product or component.

Financial health scoring component 624 may be configured to obtain financial health information in connection with a network participant (e.g., financial stress, bankruptcy, payment delinquencies, stock trends, business relationship failures, litigation judgments, receiverships, revenues, profits, cash flow, etc.), and generate a financial health score based on such financial health measures. In some embodiments, the financial health score is based on one or more of a revenue measure, a debt measure, an asset measure, a liability measure, report submitted to a securities exchange platform, a security value measure, and a security value measure.

Transactor credibility scoring component 626 may be configured to obtain the credibility scores computed in connection with all or one or more subsets of other network participants with whom the given network participant has done business in the past, and generate a transactor credibility score based on the obtained credibility scores for such other network participants. For example, the transactor credibility scoring component 626 may obtain the credibility scores of a network participant's suppliers or sellers, and/or the credibility scores of a network participant's customers or buyers, and may generate one or more transactor credibility scores based on some or all of such scores (e.g., a transactor credibility score based on the average of the credibility scores of a network participant's suppliers or sellers, a transactor credibility score based on the average of the credibility scores of a network participant's customers or buyers, or both, etc.). This way, the credibility score generated for one network participant can reflect or otherwise be based upon the credibility scores of those entities with whom the network participant deals. Thus, in some embodiments, the higher the credibility score of the business partners with whom a network participant deals, the higher the credit score of the network participant itself.

Referring still to FIG. 4, as illustrated, credibility scoring engine 600 may be coupled to weighting component 640. Weighting component 640 may be configured to apply a weighting factor to the one or more underlying scores that make up a credibility score. This may be done by applying a default weighting factor, or by applying weighting factors in accordance with a user's interest (a network participant's interests) as they consider other entities on the network with whom to transact business (other network participants). For example, the credibility scores for different network participants may be generated based on weighted underlying scores noted above—i.e., a weighted combination of an internal transaction score, an external transaction score, a transactor feedback score, a personnel feedback score, an endorsement score, a trade activity score, a financial health score, a transactor credibility score, and/or other types of scores. Consider the following example expression in equation 1 which takes the scores for N underlying sub-scores (i.e., the scores noted above), and weights the scores according to a weighting factor, w_{N}, then sums them up to obtain the overall credibility score for a particular network participant.

CREDIBILITY SCORE=(Subscore1_{Internal Transaction Score})w₁+(Subscore2_{External Transaction Score})w₂+(Subscore3_{Transactor Feedback Score})w₃+(Subscore4_{personnel Feedback Score})w₄+(Subscore5_{Endorsement Score})w₅+(Subscore6_{Trade Activity Score})w₆+(Subscore7_{Financial Health Score})w₇+(Subscore8_{Transactor Credibility Score})w₇+(FactorN_{score})w_{N} [1]

In some embodiments, weighting component 640 may be configured to obtain specific weighting preferences from a network participant, and apply such weighting factors to compute specialized credibility scores regarding the other network participants such that the network participant from whom the weighting preferences were received may view the profiles and assess credibility scores of other network participants (e.g., other entities on the network with whom to the network participant may want to transact business (other network participants)) that are tailored to the network participant's own interests. In this way, each network participant may identify preferred network participants with whom to transact business based on the factors/scores that are important to their company. For example, if a network participant has made a commitment to only transact business with companies who rank above a certain level in the Thomson Reuters sponsored D&I Index rankings, such network participant may assign higher weight, w₅, to the Subscore5_{Endorsement Score} than it assigns to other Subscore(s) in equation 1, above (or other formula as may be desired), and/or may limit the Subscore5_{Endorsement Score} variable to be exclusively based on the Thomson Reuters sponsored D&I Index, for example. Consequently, higher overall credibility scores for other network participants (as viewed through an interface associated with the network participant who designated the particular weightings) will be biased in favor of those network participants who rank higher in the Thomson Reuters sponsored D&I Index. In some embodiments, a network participant may even set a threshold score for one or more factors (i.e., subscores, or measures underlying the subscores), above or below which they will not consider transacting business with other network participants.

As will be appreciated, because a first network participant may have different weighting preferences than a second network participant (which may be obtained and effectuated via weighting component 640), other network participants' credibility scores may appear different to the first network participant and second network participant.

In some embodiments, the systems of the present disclosure are configured to provide (for access by a network participant viewing the profile of another network participant) the subscores that make up the overall credibility score, and/or the weightings that have been assigned. In some embodiments, the system may perform real-time adjustments to computed credibility scores as a network participant adjusts a particular weighting factor associated with a particular subscore. Thus, in accordance with various embodiments, the features of the present disclosure may be applied dynamically such that a network participant has a more fluid experience in assessing whether or not to transact business with another particular network participant or group of network participants.

In some embodiments, the ability of a network participant to adjust a weighting factor may be permissions-based, and may be controlled by those having authorization at the network participant company. In this way, in accordance with various embodiments, a company may impose controls over lower level employees who engage in transactions on the transaction network (e.g., only allowing the lower level employees to transact business on behalf of the company with other network participants who meet the company's defined criteria—as informed by the credibility score generated by the systems of the present disclosure).

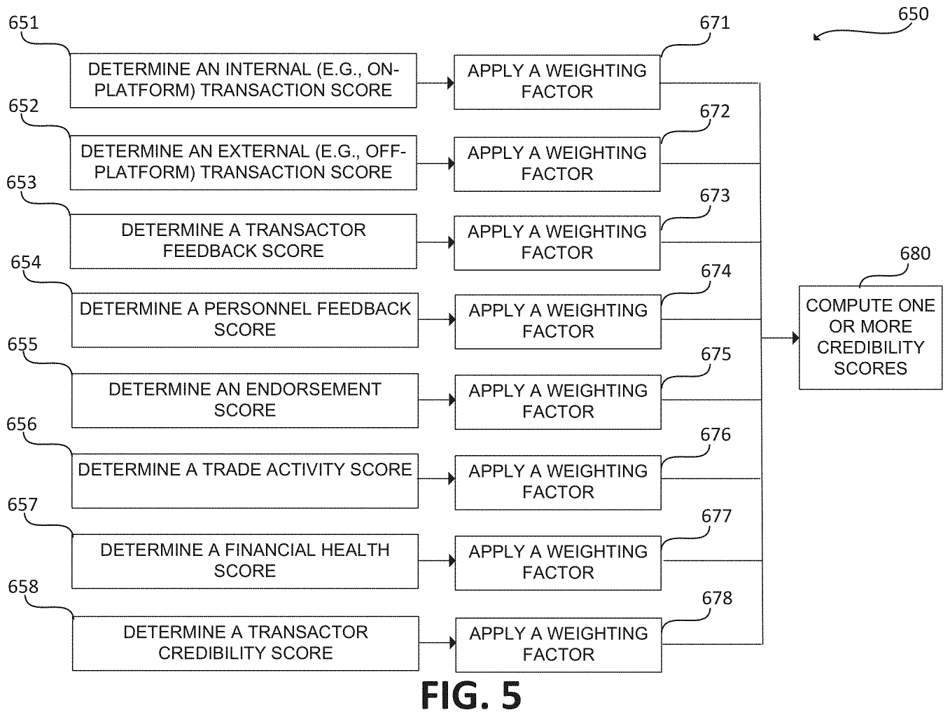

FIG. 5 illustrates an operational flow diagram illustrating an example method 650 that may be implemented in accordance with one or more embodiments of the present disclosure. At operation 651, method 650 may involve determining one or more internal transaction score(s) in accordance with one or more embodiments of the present disclosure. At operation 652, method 650 may involve determining one or more external transaction score(s) in accordance with one or more embodiments of the present disclosure. At operation 653, method 650 may involve determining one or more transactor feedback score(s) in accordance with one or more embodiments of the present disclosure. At operation 654, method 650 may involve determining one or more personnel feedback score(s) in accordance with one or more embodiments of the present disclosure. At operation 655, method 650 may involve determining one or more endorsement score(s) in accordance with one or more embodiments of the present disclosure. At operation 656, method 650 may involve determining one or more trade activity score(s) in accordance with one or more embodiments of the present disclosure. At operation 657, method 650 may involve determining one or more financial health score(s) in accordance with one or more embodiments of the present disclosure. At operation 658, method 650 may involve determining one or more transactor credibility score(s) in accordance with one or more embodiments of the present disclosure.

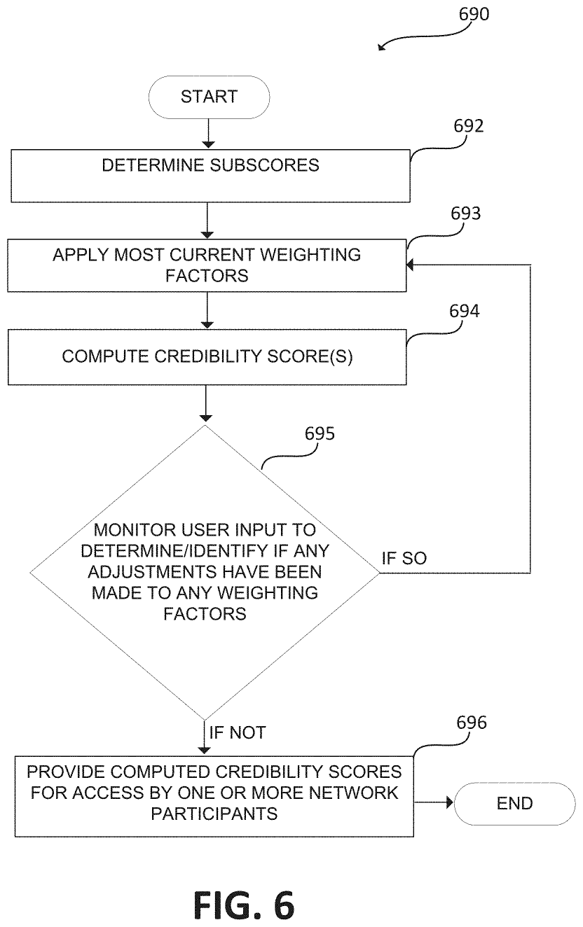

As further shown in FIG. 5, at operation 671, method 650 may involve applying a weighting factor to the internal transaction score(s) generated at operation 651, in accordance with one or more embodiments of the present disclosure. At operation 672, method 650 may involve applying a weighting factor to the external transaction score(s) generated at operation 652, in accordance with one or more embodiments of the present disclosure. At operation 673, method 650 may involve applying a weighting factor to the transactor feedback score(s) generated at operation 653, in accordance with one or more embodiments of the present disclosure. At operation 674, method 650 may involve applying a weighting factor to the personnel feedback score(s) generated at operation 654, in accordance with one or more embodiments of the present disclosure. At operation 675, method 650 may involve applying a weighting factor to the endorsement score(s) generated at operation 655, in accordance with one or more embodiments of the present disclosure. At operation 676, method 650 may involve applying a weighting factor to the trade activity score(s) generated at operation 656, in accordance with one or more embodiments of the present disclosure. At operation 677, method 650 may involve applying a weighting factor to the financial health score(s) generated at operation 657, in accordance with one or more embodiments of the present disclosure. At operation 678, method 650 may involve applying a weighting factor to the transactor credibility score(s) generated at operation 658, in accordance with one or more embodiments of the present disclosure. In some embodiments, the weighting factor may be adjustable, and systems of the present disclosure may be configured to dynamically update credibility scores based on such adjustments (discussed further in connection with FIG. 6).

By way of example, in some embodiments, a credibility score for a network participant may be based upon (1) a transactor feedback score equal to or based upon one or more peer ratings provided by the network participant's suppliers or sellers, (2) a transactor feedback score equal to or based upon one or more peer ratings provided by the network participant's customers or buyers, (3) an internal transaction score and/or external transaction score which, separately or together, are equal to or based upon a number of transactions the network participant has engaged in with suppliers or sellers; (4) an internal transaction score and/or external transaction score which, separately or together, are equal to or based upon a number of transactions the network participant has engaged in with customers or buyers; (5) an internal transaction score and/or external transaction score which, separately or together, are equal to or based upon an average transaction volume of the network participant in connection with suppliers or sellers; (6) an internal transaction score and/or external transaction score which, separately or together, are equal to or based upon an average transaction volume of the network participant in connection with customers or buyers; (7) a transactor credibility score equal to or based upon one or more credibility scores of the suppliers or sellers with whom the network participant transacted; and (8) a transactor credibility score equal to or based upon one or more credibility scores of the customers or buyers with whom the network participant transacted.

FIG. 6 illustrates an operational flow diagram illustrating an example method 690 that may be implemented in accordance with one or more embodiments of the present disclosure. At operation 692, method 690 may involve a determination of one or more subscores (e.g., the subscores discussed with reference to FIG. 5). At operation 693, method 690 may involve applying the most current weighting factors to the one or more subscores. At operation 694, method 690 may involve combining the weighted scores resulting from operation 693 to generate a credibility score. At operation 695, method 690 may involve monitoring adjustments to any of the weighting factors applied at operation 693, and if an adjustment as been made, returning to operation 693 to reapply the adjusted weighting factor(s) to the one or more subscores associated with such weighting factors, and recomputing the credibility score at operation 694 to account for such adjustments. If the monitoring operation does not detect a change in the weighting factors as previously applied, then, at operation 696 the most current credibility scores may be provided for access by one or more network participants.

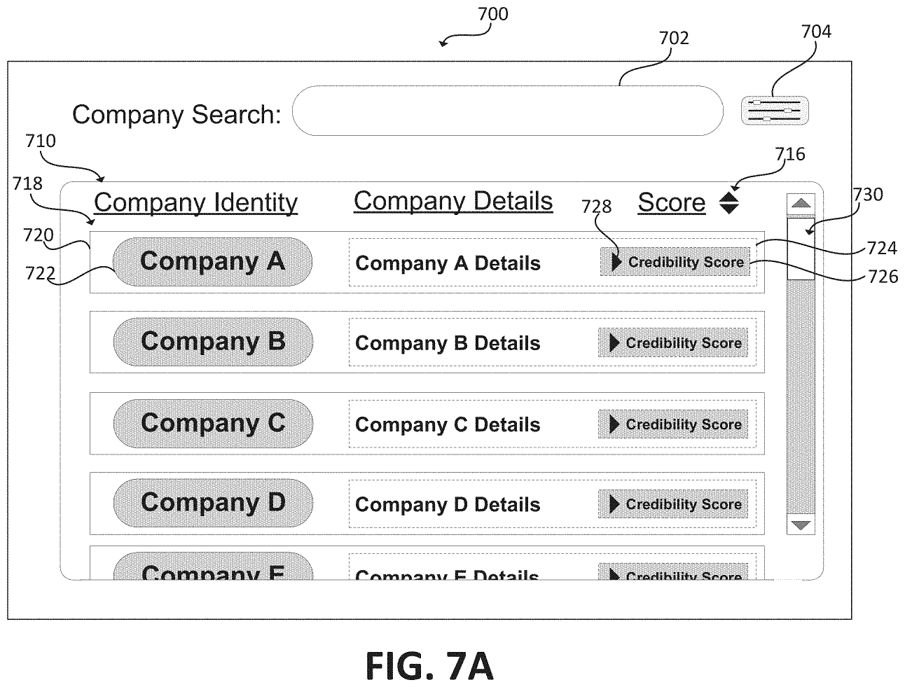

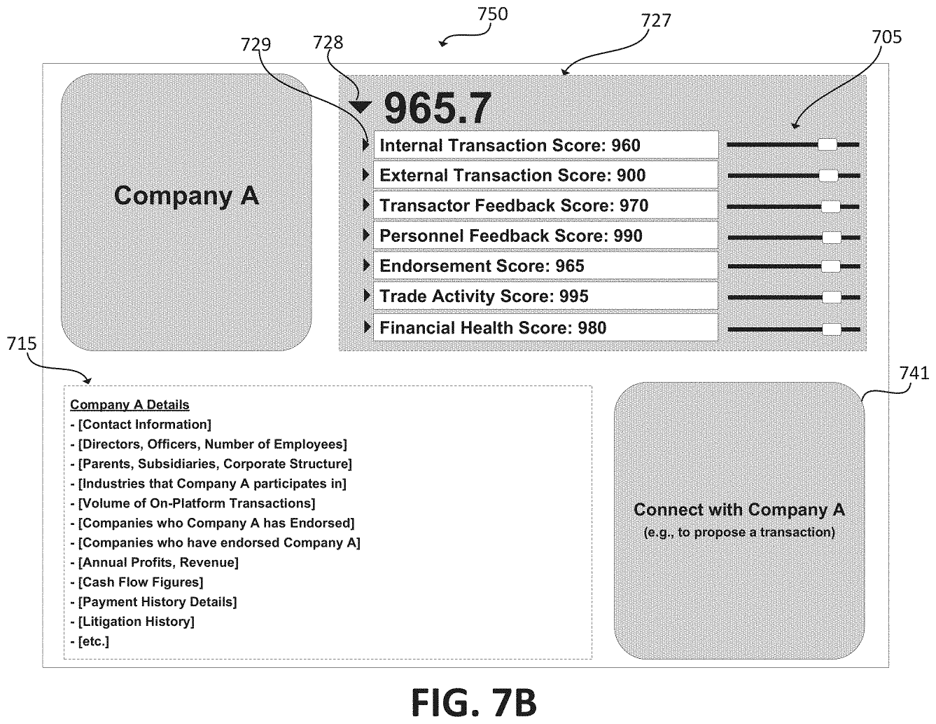

FIG. 7A illustrates an example user interface for conducting an intelligent search query to identify entities for consideration for a potential transaction, based on the disclosed credibility scores in accordance with one or more embodiments of the present disclosure. The example intelligent search query interfaces 700 of the present disclosure may provide a user with the ability to specify keywords, industries, products, or any other search term desired into a search filed 702 to identify one or more entities (other network participants) to consider for a potential transaction, where the search results are based on one or more of: (i) the overall credibility score of a pool of entities (the other network participants), and (ii) any one or more of the sub scores of the pool of entities. The intelligent search query interface 700 may be provided with a weighting button 704 wherein a user may specify or adjust one or more weighting factor(s) governing their search. Responsive to a user's initiation of a search query, the intelligent search query interface 700 may present an interactive search results field 710 including a listing 718 of one or more entities returned responsive to the search query. As shown, such a listing 718 may include a plurality of tiles (e.g., tile 720) including information associated with individual entities within the pool of entities returned responsive to the search query.

As shown, an example tile 720 may include an entity identifier 722, an entity detail 724, and a credibility score indicator 726 (which may, in some examples, be considered part of the entity details, as shown). An entity identifier may comprise any text and/or graphic associated with the entity that may be used to identify such entity. For example, an entity identifier may comprise an entity name (e.g., a company name, as shown), a logo, a badge, a trade name, a service mark, or any other indicator. An entity detail may include one or more details about the entity (e.g., entity headquarters location, phone number, etc.), or a summary of the same. A credibility score indicator 726 may include an indication of the credibility score generated in connection with the entity (based on the weighting factors of interest to the searcher, of interest the entity the searcher represents, or set by default). In some embodiments, the overall credibility score is presented as a numeric indicator (e.g., 965.7), which may in some instances be presented with a scale indication (e.g., 965.7 out of 1000). In some embodiments the overall credibility score may be presented as a graphic (e.g., a bar of a particular length, or a shape of a particular color, etc.).

As further shown in FIG. 7A, interactive search results field 710 may include one or more sorting buttons (e.g., sort button 716) associated with the listed entities. For example, while a default may be set to list search results in order of decreasing credibility score—such that the entity with the highest score appears at the top of the list 718, followed in progression by entities with lower scores down to the entity with the lowest score, which would appear at the bottom of the list 718—a searcher may select sort button 716 to resort the search results in the reverse order (i.e., entities with the lowest scores biased toward the top position in the list). Such sort buttons may be employed for any information associated with an entity and displayed in the interactive search results field 710. Results may be navigable by user selection and/or manipulation of a navigation tool (e.g., scroll slider 730).

Because the intelligent search query may be based upon the particular weighting factor settings for subscores (established by the searcher, the entity the searcher represents, or by an industry recognized default) underlying the overall credibility score, a searcher may be interested in viewing the actual underlying subscores that make up the overall credibility score. The intelligent search query interfaces 700 may provide an expand 728 button to enable viewing of the individual scores that make up the overall credibility score.

Any of the foregoing elements of the intelligent search query interfaces 700 may be selectable to reveal additional information. Said differently, additional information may be presented to a searcher responsive to such searchers selection of one or more of the elements of the intelligent search query interface 700. For example, if a searcher were to click on the entity identifier 722 for Company A, the user may be presented with a new or modified interface including additional detail in connection with Company A in particular. An example of such an interface is depicted in FIG. 7B.

FIG. 7B illustrates an example interactive detail interface 750 which may be presented responsive to user selection of one or more elements of an example intelligent search query interface in accordance with one or more embodiments of the present disclosure. As shown, interactive detail interface 750 may include representation of an additional entity details 715, additional scoring details 727, and a connection button 741 whereby the searcher (or entity the searcher represents) may connect with the entity under consideration (here, Company A).

Additional entity detail 715 may include any additional details about the entity, for example, contact information; current or past directors/officers/employees, entity parents/subsidiaries/affiliates/corporate structure; industries/organizations that the entity participates in; volume of On-Platform Transactions; endorsement information; financial information; performance information; payment history details; litigation history; stock information; or any other information (including any information considered in computing sub scores that make up an overall credibility score).

Additional scoring details 727 may include expand button 728 and subscore expand buttons 729. Expand button 728 may be selected to enable viewing of the individual subscores (shown beneath the “965.7” credibility score) that make up the overall credibility score. Subscore expand buttons 729 may be selected to enable viewing of additional details considered in computing the respective subscore (e.g., a sub-sub score). The interactive detail interface 750 may include as many expand buttons as desired for a particular application. Additional scoring details 727 may also include a weighting factor control mechanism 705, such as an input field to enter a weighting factor, or a slider or other interactive element to control, define, or adjust the weighting factors associated with a particular subscore (or sub-sub score, in examples where such capability is desired).

As shown in the example illustrated in FIG. 7B, for instance, the weighting factor control mechanism 705 comprise a series of sliders that may be manipulable to specify or adjust one or more weighting factor(s) governing the overall credibility score (here “965.7”). For simplicity, in the example shown, the sliders are positioned such that each of the shown subscores is given an equal weight. Thus, in this example, the overall score is given as an average of the depicted subscores. By providing a weighting factor control mechanism 705, the technology of the present disclosure allows the user to see, in real time, how different weighting factor settings might effect the overall score. In some embodiments, adjustments made using the weighting factor control mechanism 705 may be propagated back to the list 718 in the interactive search results field 710 (FIG. 7A) and the list 718 may be automatically resorted to reflect the new weighting factor settings. In other embodiments, global changes to the weighing factors must be entered via the intelligent search query interface itself, while in others it may be entered from any desired interface and propagated into the search results.

In some embodiments, a searcher's ability to select the expand buttons (or engage with any other features of the present disclosure) to view additional detail about a given entity may be fee, user role, permission, or authentication based (i.e., unless a fee is paid, or the searcher's role authorizes such selections, or a permission for a user account has been given the ability to make such selections, etc., the selection may not be made). Similarly, a searcher's ability to define, adjust, or otherwise control weighting factor settings may be fee, user role, permission, or authentication based.

A connection button 741 may provide a mechanism for a searcher to invite, establish, or request a connection with the entity of interest (here, Company A). For example, upon selection of connection button 741, a message may be transmitted to Company A indicating such an invitation, establishment, or request to connect (e.g., to consider a proposed transaction).

Embodiments of the present disclosure thus enable the ability to intelligently search for prospective partners for business transactions, control weighting factors that inform such searches, enable review of inputs that effect intelligent credibility scores (e.g., to visualize factors and weightings that make up the credibility score), review how the underlying scores were weighted from the original search, adjust the weighting factors to see how the score for the particular entity/company changes with such adjustments (with or without propagating the weighting change through other search results), and request to connect with an entity/company to propose a transaction.

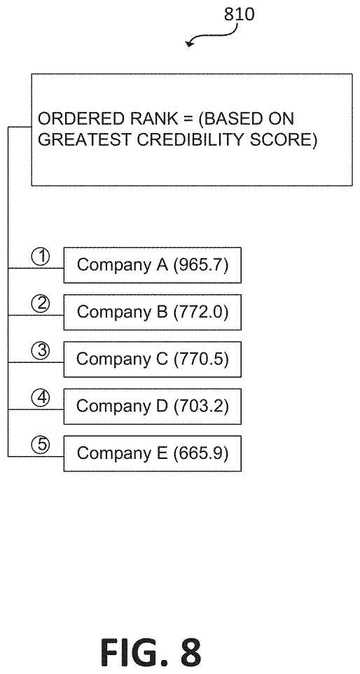

FIG. 8 illustrates an example tree structure 810 reflecting a rank of entities based on their generated credibility scores (which may be based on any one or more of the subscores described above, which may be based upon, e.g., the credibility scores of business partners, and/or transaction volume of on- and/or off-platform transactions, and/or payment history, and so forth). As shown, Company A is ranked “1” (i.e., highest in the ranking) because it has the highest credibility score, Company B is ranked “2” (i.e., second highest in the ranking) because it has the next highest credibility score, Company C is ranked “3” (i.e., third highest in the ranking) because it has the next highest credibility score, Company D is ranked “4” (i.e., fourth highest in the ranking) because it has the next highest credibility score, and Company E is ranked “5” (i.e., last in the ranking) because it has the lowest credibility score.

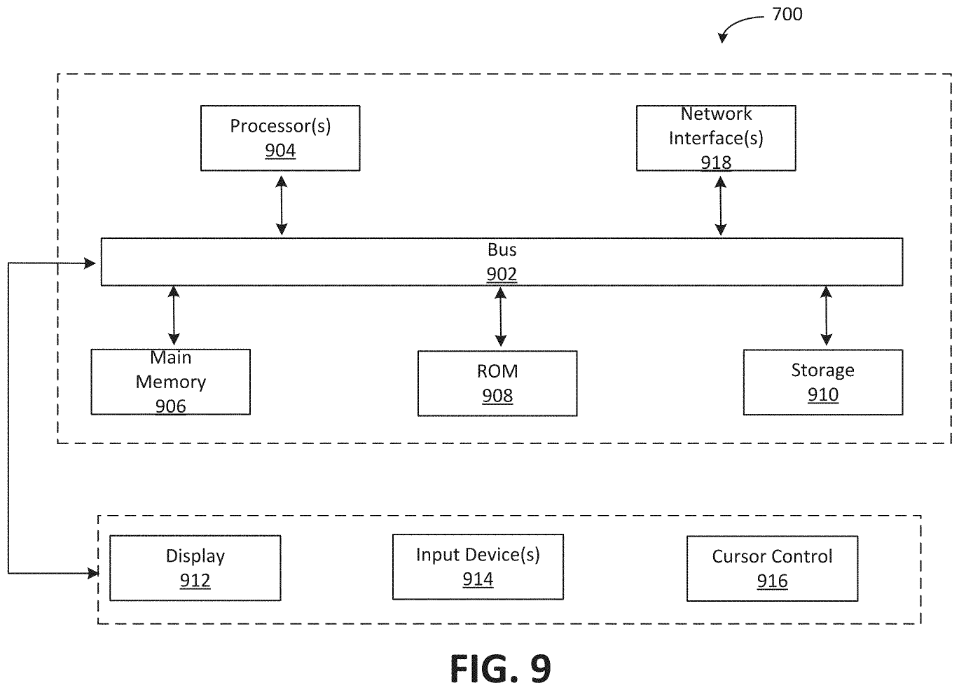

FIG. 9 depicts a block diagram of an example computer system 900 in which various of the embodiments described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions. For enhanced security, in some embodiments storage at a UNode is embodied in ROM only.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface component to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918. The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines. As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

As used herein, the term “node-independent blockchain” refers to a blockchain that is accessible to any node on a blockchain network, and where any node is eligible to participate in the consensus process. A “node-independent blockchain” may also be referred to herein as a “conventional blockchain.”

As used herein, the term “node-specific blockchain” refers to a blockchain maintained by an individual node that only includes blocks of transactions involving the network participant associated with the individual node. Only a subset of trusted nodes involved in a given transaction may participate in the consensus process for the addition of a subsequent block onto a node-specific blockchain. The right to view a node-specific blockchain maintained by a given node may be restricted to those trusted nodes that participate in a transaction with the given node. The right of such a trusted node to view a node-specific blockchain of the given node may further be restricted in time, based on the timing of a given transaction.

As used herein, the term “centralized identity” refers to a user profile of a trusted network participant that is maintained by a centralized node (e.g., the INode). The centralized identity is associated with a true identity of a network participant corresponding to a particular node (e.g., a particular UNode) within the blockchain networking environment of the present disclosure. The centralized identity may comprise any form of identifying information, such as a username, an email address, a code, etc.

As used herein, the terms “cryptocurrency” and “coin” are used interchangeably in the present disclosure, and generally refer to any tradable digital asset or digital form of currency that uses cryptography to verify and secure transactions. The transaction records embodied in the blockchain of the present disclosure can include transactions involving cryptocurrency.

As used herein, the term “hashing” is the process of taking an input and turning it into a cryptographic fixed output through a mathematical algorithm (e.g., Message Digest 5 (“MD5”), Secure Hash Algorithm (“SHA”)), for example). The output of the hashing process is referred to herein as a “hash,” and is the value returned by the mathematical algorithm based on the given input. An input can include a piece of information such as a message, a unit of data, or a cache of varying pieces of information such as a block of transactions. An input may be of an any size.

As used herein, the term “genesis block” refers to the first block of a blockchain. A genesis block can be generated by using an original set of transactions (and/or other information) which, when combined and provided as an input to a hashing process to produce a unique, original hash. Upon the occurrence of one or more new transactions (or at predetermined intervals), the original hash can be combined with the new transaction information, which can then be used as the new input to the hashing algorithm to create a brand new hash that is used to link the next block in the chain (creating a “blockchain”). Ultimately, each block in a blockchain links back to its previous block through its hash, forming a chain back to the original genesis block. For example, in embodiments of the technology of the present disclosure, transactions can be added securely as long as required nodes on the network are in consensus on what the hash should be pursuant to the Po2 Consensus Protocol.

For purposes of description the present disclosure has been explained in terms of two network participants transacting in a unique blockchain environment using, inter alia, a Proof-of-two (Po2) consensus protocol. It should be understood however that the examples provided herein should not be understood to limit the present disclosure to such embodiments. For instance, in implementations of the present technology that support transactions between more than two parties in a single transaction (e.g., a three party transaction, a five party transaction, an N-party transaction), the technology of the present disclosure may be modified to operate with a consensus protocol involving all of the participating parties (e.g., a proof-of-3 (Po3) protocol, a proof-of-5 (Po5) protocol, or, more generally, a proof-of-N (PoN) protocol where “N” represents the number of network participants that are parties to a given transaction.

Although various embodiments of the present disclosure are discussed herein in the context of blockchains, it should be understood that all such embodiments can be equally applied to distributed ledger technologies, or any modifications or variations thereon. For example, to the extent an embodiment is described in the context of a blockchain network, it should be appreciated that the embodiment may more generally be applied in a distributed ledger network.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
one or more processors; and
one or more memory devices storing instructions that, when executed by the one or more processors, cause the system to perform operations of:
generate a credibility score associated with a network participant, the credibility score based on a weighted combination of an on-platform transaction score, an off-platform transaction score, a transactor feedback score, a personnel feedback score, an endorsement score, a trade activity score, a financial health score and a transactor credibility score associated with the network participant;
wherein, to generate the credibility score, one or more weighting factors is applied to each of the on-platform transaction score, the off-platform transaction score, the transactor feedback score, the personnel feedback score, the endorsement score, the trade activity score, the financial health score, and the transactor credibility score; and
wherein the one or more weighting factors is adjustable.

2. The system of claim 1, wherein the on-platform transaction score is determined based on one or more of an on-platform transaction volume measure, an on-platform transaction value measure, and an on-platform transaction success measure associated with the network participant.

3. The system of claim 1, wherein the off-platform transaction score is based on one or more of an off-platform transaction volume measure, an off-platform transaction value measure, and an off-platform transaction success measure associated with the network participant.

4. The system of claim 1, wherein the transactor feedback score is based on feedback from one or more other network participants that have previously attempted to transact with the network participant.

5. The system of claim 1, wherein the personnel feedback score based on one or more of an employee feedback measure, and subcontractor feedback measure.

6. The system of claim 5, wherein the personnel feedback score is weighted based on the relevance of the feedback providers role in prior transactions.

7. The system of claim 1, wherein the endorsement score is based on one or more of a third-party endorsement of the network participant, and a network participant endorsement of a third-party.

8. The system of claim 7, wherein the one or more third-party endorsements correspond to a perceived attribute of the network participant.

9. The system of claim 8, wherein, the perceived attribute of the network participant corresponds to one or more of an environmental awareness measure, a diversity measure, a fiscal responsibility measure, an animal cruelty measure, an employment practice measure, a political preference measure, and a religious preference measure, a fraudulent activity measure, a public perception measure, a public interest measure, and a donation measure.

10. The system of claim 1, wherein the trade activity score is based on one or more of an import measure and an export measure of the network participant;

11. The system of claim 10, wherein the trade activity score is based only upon those import measures and export measures that are specific to one or more of a product or service.

12. The system of claim 1, wherein the financial health score is based on one or more of a revenue measure, a debt measure, an asset measure, a liability measure, report submitted to a securities exchange platform, a security value measure, and a security value measure.

13. A method, comprising:
determining a credibility score associated with a network participant, the credibility score based on a weighted combination of an on-platform transaction score, an off-platform transaction score, a transactor feedback score, a personnel feedback score, an endorsement score, a trade activity score, a financial health score, and a transactor credibility score associated with the network participant;
wherein, to determine the credibility score, one or more weighting factors is applied to each of the on-platform transaction score, the off-platform transaction score, the transactor feedback score, the personnel feedback score, the endorsement score, the trade activity score, and the financial health score; and
wherein the one or more weighting factors is adjustable;

14. The method of claim 13, wherein the on-platform transaction score is determined based on one or more of an on-platform transaction volume measure, an on-platform transaction value measure, and an on-platform transaction success measure associated with the network participant.

15. The method of claim 13, wherein the off-platform transaction score is based on one or more of an off-platform transaction volume measure, an off-platform transaction value measure, and an off-platform transaction success measure associated with the network participant.

16. The method of claim 13, wherein the transactor feedback score is based on feedback from one or more other network participants that have previously attempted to transact with the network participant.

17. The method of claim 13, wherein the personnel feedback score based on one or more of an employee feedback measure, and subcontractor feedback measure.

18. The method of claim 17, wherein the personnel feedback score is weighted based on the relevance of the feedback providers role in prior transactions.

19. The method of claim 13, wherein the endorsement score is based on one or more of a third-party endorsement of the network participant, and a network participant endorsement of a third-party.

20. The method of claim 19, wherein the one or more third-party endorsements correspond to a perceived attribute of the network participant.

21. The method of claim 20, wherein, the perceived attribute of the network participant corresponds to one or more of an environmental awareness measure, a diversity measure, a fiscal responsibility measure, an animal cruelty measure, an employment practice measure, a political preference measure, and a religious preference measure, a fraudulent activity measure, a public perception measure, a public interest measure, and a donation measure.

22. The method of claim 13, wherein the trade activity score is based on one or more of an import measure and an export measure of the network participant;

23. The method of claim 22, wherein the trade activity score is based only upon those import measures and export measures that are specific to one or more of a product or service.

24. The method of claim 13, wherein the financial health score is based on one or more of a revenue measure, a debt measure, an asset measure, a liability measure, report submitted to a securities exchange platform, a security value measure, and a security value measure.

25. The system of claim 1, wherein the transactor credibility score is based on the credibility score of another network participant with whom the network participant has transacted.

26. The system of claim 13, wherein the transactor credibility score is based on the credibility score of another network participant with whom the network participant has transacted.
